(19) United States
(12) Patent Application Publication
(10) Pub. No.: US 2014/0099004 A1
(43) Pub. Date: Apr. 10, 2014

(54) MANAGING REAL-TIME COMMUNICATION SESSIONS

(71) Applicants: Christopher James DiBona, Mountain View, CA (US); Daniel Berlin, North Potomac, MD (US)

(72) Inventors: Christopher James DiBona, Mountain View, CA (US); Daniel Berlin, North Potomac, MD (US)

(21) Appl. No.: 13/648,968

(22) Filed: Oct. 10, 2012

(51) Int. Cl. H04N 7/14; G06F 3/033; G06K 9/62; G10L 17/00

(52) U.S. Cl. 382/118; 348/14.12; 704/275; 345/158; 348/E07.077

(57) ABSTRACT

An example method includes receiving, by a host system including at least one processor, a first video stream from a first client device and a second video stream from a second client device, where the host system, the first client device, and the second client device are communicatively coupled to a real-time communication session. The method further includes detecting, by the host system and in the second video stream, a disconnection condition including at least one of a visual disconnection condition and an auditory disconnection condition. The method further includes responsive to detecting the disconnection condition, disconnecting, by the host system, the second client device from the real-time communication session.

### TECHNICAL FIELD

The disclosure relates to real-time communication sessions.

### BACKGROUND

A user may socialize with his/her contacts by chatting, watching television or videos, playing games, or engaging in other activities with his/her contacts. In some instances, a user and his/her contacts may not be in the same physical location. Instead, the user and his/her contacts may rely on other mechanisms to socialize, such as talking on the phone, sending email, or text messaging.

### SUMMARY

In one example, a method includes receiving, by a host system including at least one processor, a first video stream from a first client device and a second video stream from a second client device, where the host system, the first client device, and the second client device are communicatively coupled to a real-time communication session. The method further includes detecting, by the host system and in the second video stream, a disconnection condition including at least one of a visual disconnection condition and an auditory disconnection condition. The method further includes responsive to detecting the disconnection condition, disconnecting, by the host system, the second client device from the real-time communication session.

In another example, a computer-readable storage device is encoded with instructions that, when executed, cause one or more programmable processors of a host system to receive a first video stream from a first client device and a second video stream from a second client device, where the host system, the first client device, and the second client device are communicatively coupled to a real-time communication session. The instructions further cause the programmable processor(s) to detect, in the second video stream, a disconnection condition including at least one of a visual disconnection condition and an auditory disconnection condition. The instructions further cause the programmable processor(s) to, responsive to detecting the disconnection condition, disconnect the second client device from the real-time communication session.

In another example, a host system includes a network interface, a memory, and one or more programmable processors. The programmable processor(s) are configured to receive, using the network interface, a first video stream from a first client device and a second video stream from a second client device, where the host system, the first client device, and the second client device are communicatively coupled to a real-time communication session. The programmable processor(s) are further configured to detect, in the second video stream, a disconnection condition including at least one of a visual disconnection condition and an auditory disconnection condition, and to, responsive to detecting the disconnection condition, disconnect the second client device from the real-time communication session.

The details of one or more examples are set forth in the accompanying drawings and the description below. Other features, objects, and advantages of this disclosure will be apparent from the description and drawings, and from the claims.

### BRIEF DESCRIPTION OF DRAWINGS

FIG. 1 is a block diagram illustrating an example of a real-time communication session between various client devices, managed by a host system, in accordance with one or more techniques of this disclosure.

FIG. 2 is a block diagram illustrating an example host device that may implement one or more real-time communication management techniques of this disclosure.

FIGS. 3A & 3B illustrate example user interfaces (UIs) that a client device may display, in accordance with one or more techniques of this disclosure.

FIG. 4 is a flowchart illustrating an example process that a computing device may perform, in accordance with one or more aspects of this disclosure.

### DETAILED DESCRIPTION

Co-workers, friends, family members, or other individuals who wish to collaborate, socialize, or otherwise communicate may be dispersed geographically. When dispersed geographically, some individuals may rely on various forms of telephony, text messaging, email, or other forms of communication that support limited forms of socializing. However, these forms of communication may not give users an experience comparable to collaborating in person. Techniques of the present disclosure may provide one or more mechanisms for users in different locations to socialize in a shared virtual location (e.g., engage in a “real-time communication session” or a “virtual collaboration session”). A real-time communication session may enable multiple users to participate in video and/or audio chat, collaboratively edit documents, share and watch videos, share and listen to audio streams, play games, collaboratively browse the Internet, or combinations thereof.

In general, techniques of the present disclosure are directed to the management and administration of real-time communication sessions. In various examples, the techniques may be implemented on different types of devices in a real-time communication session, such as one or more host systems (e.g., host devices such as servers, etc.), client devices (which may include computing devices of varying configurations), and others. While participating in a real-time communication session, such as a video conference, a user may forget or otherwise neglect to disconnect his/her respective computing device from the video conference. In turn, the client device may continue to transmit video and/or audio data captured from the client device's surroundings. Such transmission may cause several potential issues, such as distracting the remaining participants in the video conference, unnecessary consumption of computing resources and network bandwidth, transmission of video and/or audio associated with people who are unaware of the resulting loss of privacy, and the like.

Techniques of this disclosure may enable the disconnection of a client device from a video conference based on a determination that one or more users of the client should have actively disconnected from the client device from the video conference, but may have neglected to do so. In some implementations, a host system that manages the video conference may implement facial detection techniques to determine a disconnection condition, such as the absence of any human face for a predetermined timeout period from a video stream transmitted by a client device. In these and other implementations, the host system may implement facial recognition techniques to identify a particular participant associated with the client device, and determine the disconnection condition based on an absence of the identified user for the predetermined time period from the received video streams. In still other implementations, the host system may implement speech recognition and/or voice recognition techniques to determine auditory disconnection conditions, such as silence, non-speech noise, voices other than the voice of an identified user, conversation-concluding phrases, and others.

The techniques described herein provide several potential advantages. As one example, a host system may intuitively disconnect a client device from a video conference, thereby mitigating the amount of irrelevant video and/or audio data distributed to the other client devices in the video conference. As another example, the host system may preserve the privacy interests of users who intended to leave the video conference, but may have neglected to disconnect their respective client devices from the video conference (e.g., by shutting down or hibernating the client device, stopping execution of client video conferencing programs). As yet another example, the host system may conserve computing resources on the disconnected client device and conserve network bandwidth that is otherwise required to keep such a client device active in the video conference. Additionally, while described largely herein with respect to a host system, it will be appreciated that the techniques of this disclosure may be implemented on various devices such as on various client devices. In this manner, the techniques may provide several potential advantages which may be availed of via various implementations.

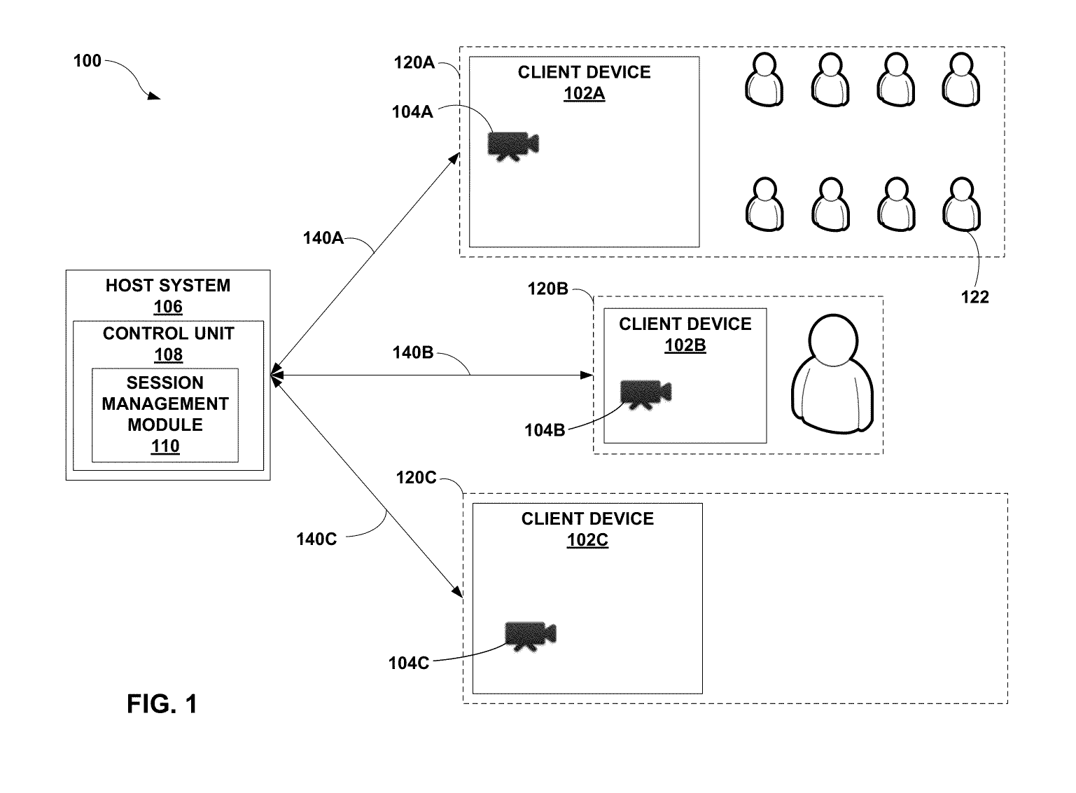

FIG. 1 is a block diagram illustrating example system 100 that includes a real-time communication session for various client devices 102A-102C (“client devices 102”), managed by host system 106. Each of client devices 102 may be at remote locations 120A-120C (“locations 120”). Examples of client devices 102 include computers, tablets, phones, and TV-like devices, including televisions with one or more processors attached thereto or embedded therein. Client devices 102 may be equipped with input devices capable of capturing various types of media, such as still cameras and text entry devices. In the specific example of FIG. 1, each of client devices 102 may include or be otherwise coupled to respective cameras 104A-104C (“cameras 104”), each of which may provide video capture capabilities. In various implementations, one or more of client devices 102 may include or be otherwise coupled to audio capture devices, such as microphones (not shown for ease of illustration purposes only).

Client devices 102 may communicatively couple to a real-time communication session, such as a video conference, managed by host system 106. In various implementations, host system 106 may include one or more computing devices configured to manage a video conference. As one example, host system 106 may include a single server device. As another example, host system 106 may include a plurality of devices, such as any combination of servers, routers, and other devices known in the art that may be configured to perform one or more functionalities described herein with respect to host system 106. In other words, the functionalities of host system 106 may performed by a single device, or distributed across multiple devices, in various implementations of the techniques of this disclosure.

As shown in FIG. 1, host system 106 may include control unit 108. Control unit 108 may, in various implementations, include any combination of one or more processors, one or more field programmable gate arrays (FPGAs), one or more application specific integrated circuits (ASICs), and one or more application specific standard products (ASSPs). Control unit 108 may also include memory, both static (e.g., hard drives or magnetic drives, optical drives, FLASH memory, EPROM, EEPROM, etc.) and dynamic (e.g., RAM, DRAM, SRAM, etc.), or any other computer-readable storage device or non-transitory computer readable storage medium capable of storing instructions that cause the one or more processors (e.g., control unit 108) to perform the efficient network management techniques described in this disclosure. Thus, control unit 108 may represent hardware or a combination of hardware, firmware, and software to support the below described components, modules or elements, and the techniques should not be strictly limited to any particular implementation described herein. In implementations where host system includes a plurality of devices, control unit 108 may represent a plurality of sub-control units, with each sub-control unit including one or more of the components and/or functionalities listed above.

Additionally, host system 106 may include session management module 110. Session management module 110 may be configured or otherwise operable to manage one or more real-time communication sessions, such as video conferences. Additionally, session management module 110 may be configured or otherwise operable to implement one or more techniques described herein. As examples, session management module 110 may detect disconnection conditions associated with one or more of client devices 102. Examples of such disconnection conditions include visual disconnection conditions and auditory disconnection conditions, which are described in more detail below. Responsive to detecting the disconnection condition(s), session management module 110 may disconnect the corresponding one or more of client devices 102 from the real-time communication session.

As shown in FIG. 1, client devices 102 may communicate with host system 106 during the real-time communication session through audio/visual streams 140A-140C (“AV streams 140”). More specifically, client devices 102 may be communicatively coupled to host system 106 via systems including the Internet, local area networks (LANs), wide area networks (WANs), metropolitan area networks (MANs), wireless protocols such as third generation (3G) and fourth generation (4G) cellular networks, Bluetooth® connections, and various others. Additionally, client devices 102 may serve various numbers of participants. In the non-limiting (yet illustrative) example of FIG. 1, client device 102A is used by a group of eight participants (e.g., first location 120A may be a conference room or the like). In contrast, in client device 102B is used by a single participant. For ease of discussion purposes only, client device 102B is described herein as a mobile computing device, such as a smartphone.

In the example of FIG. 1, client device 102C does not serve any participants in the real-time communication session. More specifically, client device 102C may continue to send and receive data as part of AV stream 140C even after all participants leave third location 120C. As described, a last participant to leave 120C may intend to cease participation in the real-time communication session managed by host system 106, but may neglect to disconnect client device 102C from the real-time communication session (e.g., by physically or logically disconnecting client device 102C from a network connection, by stopping execution of conferencing client software running on client device 102C, and others). In this example, client device 102C may continue to generate and transmit AV stream 140C, which may in turn include video and/or audio data that reflects events occurring at third location 120C.

By transmitting AV stream 140C when no participant intends to communicate using the real-time communication session, client device 102C may compromise the privacy concerns of individuals who may enter third location 120C, without knowledge of the transmission. Additionally, by continuing to transmit and receive AV stream 140C, client device 102C may expend power and computing resources unnecessarily, and consume bandwidth over the communicative connection with host system. For these and other reasons, host system 106 may more effectively manage the real-time communication session by disconnecting client device 102C based on detection of one or more disconnection conditions in AV stream 140C.

Session management module 110 may be configured or otherwise operable to detect disconnection conditions in one or more of AV streams 140, and disconnect respective client device(s) 120 based on a detected disconnection session. In some implementations, session management module 110 may be equipped with or otherwise have access to one or more facial detection programs. In these implementations, session management module 110 may use the facial detection programs to detect one or more visual disconnection sessions in AV streams 140. As one example, session management module 110 may detect representations of eight faces in AV stream 140A, a representation of one face in AV stream 140B, and no representation of a face in AV stream 140C. Based on a failure to detect a representation of a face in AV stream 140C, session management module 110 may cause host system 106 to disconnect client device 102C from the real-time communication session.

In some examples where session management module 110 uses the facial detection program(s) to detect visual disconnection conditions, session management module 110 may use other criteria, in combination with results output by the facial detection program(s) to determine whether the visual disconnection condition exists. For example, session management module 110 may detect a visual disconnection session for client device 102 if the facial detection program(s) fail to detect a representation of a human face in AV stream 140C for a predetermined period of time (e.g., a “timeout period”). Session management module 110 may extrapolate various time periods, such as a period of time for which AV stream 140C does not include a representation of a face, using various metrics. Examples of such metrics include, but are not limited to, a number of frames and embedded time stamps.

In some enhanced implementations, session management module 110 may have access to one or more facial recognition programs. Session management module 110 may use the facial recognition program(s) either as a supplement to the facial detection program(s), or independently of the facial detection programs. In certain examples, session management module 110 may use the facial recognition program(s) to identify particular participants using one of client devices 102. For example, session management module 110 may use the facial recognition program(s) to extract, from one or more frames of AV stream 140A, a facial image of one of the participants at first location 120A (e.g., a facial image of main participant 122). Session management module 110 may designate main participant 122 based on various criteria, such as through a user account used to sign in to the real-time communication session, main participant 122 being the first participant detected in AV stream 140A, and an explicit request entered by a participant using client device 102A, to name only a few non-limiting examples.

In these implementations, session management module 110 may cause the facial recognition program(s) to store the facial image of main participant 122 as a reference image. Subsequently, during the current and/or future real-time communication sessions, session management module 110 may use the facial recognition program(s) to periodically match representations of faces in AV stream 140A to the stored reference facial image of main participant 122. If the facial recognition program(s) fail to match any facial images in AV stream 140A to the stored reference facial image, session management module 110 may, under various circumstances, detect a visual disconnection condition. In one example, a failure to match a facial image to the stored reference facial image, even in a single frame, may automatically trigger the visual disconnection condition.

In other examples, session management module 110 may detect the visual disconnection condition based on a failure to match the facial images in a predetermined number of frames of AV stream 140A. In some such implementations, session management module 110 may further analyze the predetermined number of frames to determine whether the frames are sequential. For example, if session management module 110 detects that main participant 122 is absent from the real-time communication session for the predetermined number of frames, but that the frames are interspersed (e.g., not sequential), session management module 110 may determine that main participant 122 did not intend to leave the real-time communication session, but instead left first location 120A for a brief time with an intent to return (e.g., to take a personal phone call, personally greet a visitor, and others).

However, if main participant 122 is absent from the real-time communication for a sequence of consecutive frames equaling the predetermined number of frames, session management module 110 may determine that main participant 122 has left first location 120A with an intention to leave the real-time communication session. In some examples, session management module 110 may correlate the number of sequential frames to a predetermined period of time, such as the timeout period described above with respect to the facial detection techniques of this disclosure. For example, session management module 110 may derive the period of time using a known frame rate of video transmitted by each of client devices 102. In instances where two or more of client devices 102 transmit video data at different frame rates, session management module 110 may detect a visual disconnection condition based on different numbers of sequential frames. In this manner, session management module 110 may use facial detection and/or facial recognition program(s) to detect a visual disconnection session based on various criteria.

In some examples, session management module 110 may detect a visual disconnection condition based on factors such as inactivity discerned from one or more of AV streams 140. As one example, session management module 110 may analyze video data of AV stream 140B to determine that the sole participant at second location 120B is inactive in terms of participating in the real-time communication session. In various scenarios, inactivity of a participant may indicate that the participant is not vital to the progress of the real-time communication session, and session management module 110 may disconnect the inactive participant's client device in order to conserve bandwidth, reduce distraction caused to other participants in the session, among other purposes.

In certain examples, session management module 110 may determine that the participant at second location 120B is inactive based on visual transitions among frames of AV stream 140B. For example, session management module 110 may determine changes between two or more consecutive frames (e.g., a sequence of frames) of AV stream 140B. Changes between frames within a sequence may indicate activity, such as through movement of a participant's mouth to indicate verbal communication, facial expressions to indicate reactions to communications of other participants, body gestures to indicate non-verbal communication, introduction of demonstrative items (such as drawings) to communicate with other participants, among others. If session management module 110 determines that changes among a sequence of frames of AV stream 140B are less than a threshold change value, session management module 110 may determine that the participant using client device 102B is inactive. Based on the inactivity of the participant, session management module 110 may detect a visual disconnection condition associated with client device 102B, and, in some situations, cause host device 106 to disconnect client device 102B from the real-time communication session.

Session management module 110 may, in some examples, detect a visual disconnection condition based on certain specific body movements associated with participants. For example, session management module 110 may implement techniques of this disclosure to detect a standing gesture (e.g., a transition of a participant from a sitting posture to an upright posture) as part of identifying a visual disconnection condition. In some implementations, session management module 110 may detect the visual disconnection condition based on a number and/or ratio of participants who perform the standing gesture. As one example, session management module 110 may detect the visual disconnection condition only when all participants across locations 120 perform the standing gesture. As another example, session management module 110 when all participants at a single location, such as first location 120A, perform the standing gesture, leaving only second location 120B without a disconnection condition. As yet another example, session management module 110 may detect the visual disconnection condition when a specific participant, such as main participant 122 performs the standing gesture. In this manner, session management module 110 may implement techniques of this disclosure to detect visual disconnection conditions by detecting one or more body movements in AV streams 140.

In these and other examples, session management module 110 may detect a disconnection condition in one or more of AV streams 140 based on analysis of audio data. Disconnection conditions discerned from audio components of AV streams 140 may be referred to herein as auditory disconnection conditions. In various implementations, session management module 110 may be equipped with (or otherwise have access to) speech recognition program(s) and/or voice recognition program(s). In such implementations, session management module 110 may use one or both of the speech recognition and voice recognition program(s) to analyze audio data of AV streams 140 for auditory disconnection conditions.

Using one or both of speech recognition and voice recognition program(s), session management module 110 may detect an auditory disconnection condition based on voice data included in audio streams 140. In some implementations, session management module 110 may analyze the audio portions of AV streams 140 to determine whether AV streams 140 include sufficient audio data. If session management module 110 detects that one or more of AV streams 140 includes insufficient audio data, session management module 110 may detect an auditory disconnection session with respect to the respective device(s) of client devices 102.

Session management module 110 may detect insufficient audio data in a number of ways. As one example, session management module 110 may determine that AV stream 140B includes non-voice audio data. For instance, session management module 110 may use the speech recognition program(s) to detect that the audio data of AV stream 140B includes sounds that are not consistent with human speech. Examples of such sounds may include extraneous noise, such as movement of heavy objects, sounds emitted by vehicles, and others. In some implementations, session management module 110 may compare the amount of non-voice audio data to the amount of voice data in AV stream 140B. If the amount of non-voice audio data is greater than the amount of voice data, session management module 110 may detect the auditory disconnection condition. In other implementations, session management module 110 may approximate or calculate a proportion of AV stream 140B that includes non-voice audio data. If the proportion of AV stream 140B that includes non-voice audio data is greater than a threshold percentage, session management module 110 may detect the auditory disconnection condition, and disconnect client device 102B from the real-time communication session.

In some examples, session management module 110 may detect an auditory disconnection condition based on insufficient audio data using silence displayed in AV streams 140. As discussed, in the example of FIG. 1, all participants previously using client device 102C may have left third location 120C. As a result, client device 102C may not transmit any audio data as part of AV stream 140C. In this example, session management module 110 may detect that host system 106 has not received audio data in conjunction with a sequence of frames of AV stream 140C (e.g., the sequence may indicate a threshold time period). As a result, session management module 110 may detect the auditory disconnection condition based on a lack or absence of audio data in AV stream 140C for the threshold time period, and disconnect client device 102C from the real-time communication session. In this manner, session management module 110 may implement one or more of the techniques of this disclosure to detect disconnection conditions, such as auditory disconnection conditions, using audio data of AV streams 140.

In some implementations, session management module 110 may use the speech recognition program(s) to detect particular words or phrases in the audio portions of AV streams 140. For example, session management module 110 may use the speech recognition program(s) to detect words or phrases that are commonly used to conclude a conversation. Some examples of conversation-concluding phrases include “see you later,” “goodbye,” “take care,” and others. As shown, conversation-concluding phrases may vary in length, from a single word to multiple words.

In these implementations, session management module 110 may detect a disconnection condition (such as an auditory disconnection condition) based on the detection of one or more conversation-concluding phrases. In one example, session management module 110 may detect the auditory disconnection condition based on detection of at least a conversation-concluding phrase in at least two of AV streams 140. In this and other examples, session management module 110 may wait for a predetermined time period after detection of a conversation-concluding phrase to determine whether two or more remaining participants continue to communicate over the real-time communication session. As one example, the conversation-concluding phrases may indicate that a single participant at first location 120A is preparing to leave the real-time communication session, and that the participant at second location 120B acknowledges the departure of the participant leaving first location 120A. In this example, the remaining participants of the real-time communication session may continue to communicate after a brief pause. In this manner, session management module 110 may implement the techniques of this disclosure to accommodate departures of some participants from the real-time communication session while allowing remaining participants to continue communicating over the real-time communication session.

Additionally, in some enhanced implementations, session management module 110 may use the voice recognition program(s) to track the activity of a specific participant, such as main participant 122. As described above with respect to the use of facial recognition program(s), session management module 110 may identify main participant 122 in a variety of ways. Additionally, in implementations where session management module 110 has access to voice recognition program(s), session management module 110 may use voice data included in AV stream 140A to detect auditory disconnection conditions associated with client device 102A. More specifically, session management module 110 may monitor the audio portion of AV stream 140A to discern one or more of the amount, continuity, and quality of activity associated with main participant 122.

In some examples, session management module 110 may determine, using the voice recognition program(s), whether the audio portion of AV stream 140A includes audio data of at least a threshold length matches a representation of the voice of main participant 122. In such examples, session management module 110 may determine that the level of activity of main participant 122 is inadequate to indicate active participation in the real-time communication session. Responsive to this determination, session management module 110 may detect an auditory disconnection condition associated with client device 102A, and disconnect client device 102A from the real-time communication session. In this example, session management module 110 may designate the voice of main participant 122 as an authorized voice (e.g., session management module 110 may use an absence of authorized voice audio data in AV stream 140A to detect an auditory disconnection condition of client device 102A).

In one such example, session management module 110 may use the voice recognition program(s) executable by host system 106 to determine whether AV stream 140A includes contiguous audio data matching the voice of main participant 122 for at least the threshold length. In other words, session management module 110 may use the voice recognition program(s) to determine continuity of audio data matching the voice of main participant 122. By monitoring continuity, session management module 110 may identify scenarios in which main participant 122 participates intermittently (e.g., providing cursory verbal responses). In turn, if session management module 110 determines that AV stream 140A includes insufficient audio data matching the voice of main participant 122, session management module 110 may detect an audio disconnection condition for client device 102A based on a lack of continuous activity by main participant 122.

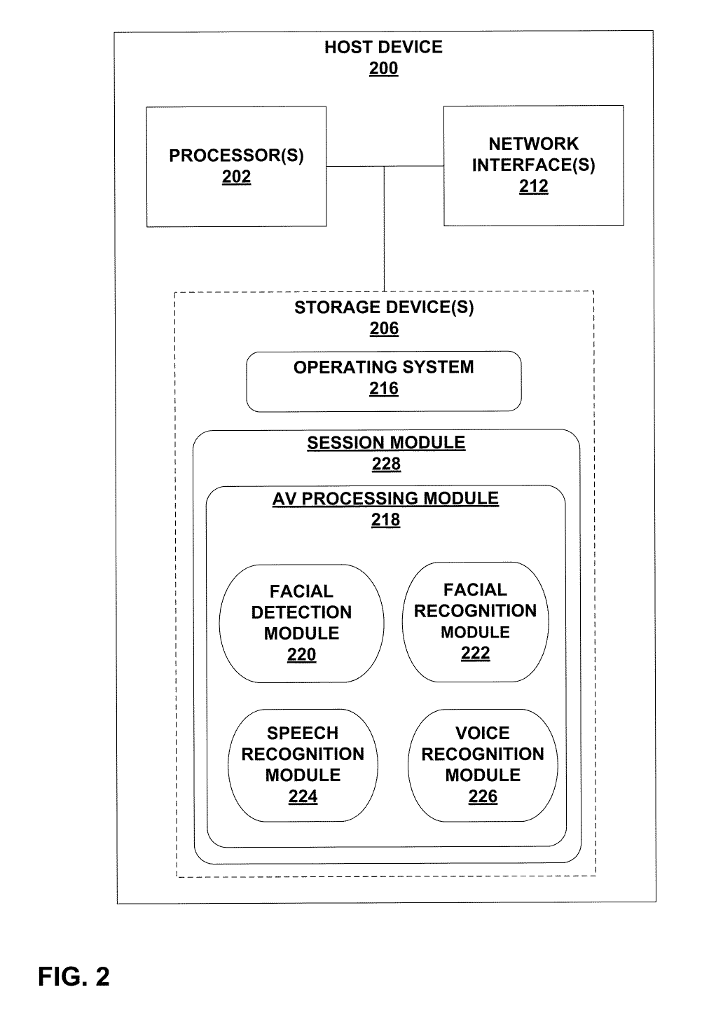

FIG. 2 is a block diagram illustrating an example host device 200 that may implement one or more real-time communication management techniques of this disclosure. In various examples, host device 200 may be one possible implementation of host system 106 described with respect to FIG. 1, a component of host system 106 (e.g., in implementations where host system 106 includes multiple computing devices), and others. As shown in FIG. 2, host device 200 may include one or more processors 202, one or more network interfaces 212, and one or more storage devices 206. Additionally, storage device(s) may store portions one or both of operating system 216 and session module 228. Session module 228 may include audio/video (AV) processing module 218, which in turn may include one or more of facial detection module 220, facial recognition module 222, speech recognition module 224, and voice recognition module 226. In various implementations, host device 200 may include components not illustrated in FIG. 2, such as various input and/or output devices, and others.

One or more processors 202 are, in various examples, configured to implement functionality and/or process instructions for execution within computing device 200. For example, processors 202 may process stored on or otherwise accessible through storage devices 206. Such instructions may include components of operating system 216, AV processing module 218, facial detection module 220, facial recognition module 222, speech recognition module 224, and voice recognition module 226.

Host device 200, in some examples, also includes one or more network interfaces 212. Host device 200, in one example, utilizes network interface(s) 212 to communicate with external devices via one or more networks, such as one or more wireless networks. Network interface(s) 212 may be a network interface card, such as an Ethernet card, an optical transceiver, a radio frequency transceiver, or any other type of device that can send and receive information. Other examples of such network interfaces may include Bluetooth®, 3G, 4G, and WiFi® radios in mobile host devices as well as universal serial bus (USB). In some examples, host device 200 utilizes network interface(s) 212 to wirelessly communicate with external devices, such as one or more client devices, over a network.

Operating system 216 may control one or more functionalities of host device 200 and/or components thereof. For example, operating system 216 may interact with session module 228 (and components thereof), and may facilitate one or more interactions between applications 230 and one or more of processor(s) 202, network interface(s) 212, and remote computing devices through use of network interface(s) 212. In some examples, one or more of session module 228, AV processing module 218, facial detection module 220, facial recognition module 222, speech recognition module 224, and voice recognition module 226 may be included in operating system 216. In other examples, one or more of session module 228, AV processing module 218, facial detection module 220, facial recognition module 222, speech recognition module 224, and voice recognition module 226 may be implemented externally to host device 200, such as at a network location. In some such instances, host device 200 may use network interface(s) 212 to access and implement functionalities provided by session module 228 and its components, through methods commonly known as “cloud computing.”

Session module 228 may be one non-limiting example of session management module 110 described with respect to FIG. 1. Similarly to session management module 110, session module 228 may enable host device 200 to host, manage, and administrate one or more real-time communication sessions between client devices communicatively coupled to host device 200. In various scenarios, session module 228 may enable host device 200 to demarcate different real-time communication sessions that run concurrently, add or remove client devices from a particular real-time communication session, merge various real-time communication sessions, and others.

As shown in FIG. 2, session module 228 may include AV processing module 218. AV processing module 218 may be configured or otherwise operable to analyze video streams, audio streams, and combinations of the two (audio/video, or AV streams). In various examples, AV processing module 218 may enable host device 200 to analyze various characteristics of AV streams received using network interface(s) 212. Such characteristics may include audio characteristics, including pitch and volume, as well as visual characteristics, such as color, contrast, and brightness.

Additionally, AV processing module 218 may use one or more of facial detection module 220, facial recognition module 224, speech recognition module 224, and voice recognition module 226 to implement various real-time communication session management techniques of this disclosure. For example, facial detection module 220 may be configured or otherwise operable to detect a representation of a user's face in a received video stream. If, subsequent to detecting the representation of the user's face, facial detection module 220 determines that the representation of the user's face is absent from the received video stream, facial detection module 220 may detect a visual disconnection condition with respect to the client device that sent the video stream.

In some implementations, AV processing module 218 may use facial recognition module 222 to perform one or more of the real-time communication session management techniques described herein. For example, facial recognition module 222 may store a facial image (e.g., extracted from a frame of a received video stream) as a reference image for facial recognition purposes. In this example, facial recognition module 222 may extract one or more facial images from subsequent frames of the received video stream, and compare the extracted facial images to the stored reference facial image. Facial recognition module 222 may perform the comparison using one or more recognition algorithms (e.g., one or more well-known recognition algorithms), such as geometric and/or photometric approaches, three-dimensional (3D) modeling and recognition techniques, principal component analysis using eigenfaces, linear discriminate analysis, elastic bunch graph matching, pattern matching, and dynamic link matching, to name just a few. Based on comparison-based values, such as preprogrammed acceptable margins of error, facial recognition module 222 may determine whether or not the authentication image and the enrollment image are sufficiently similar to one another for facial recognition.

Based on the comparison, facial recognition module 222 may determine whether or not the extracted facial image(s) match the stored reference facial image. If a predetermined number of the extracted facial image(s) do not match the stored reference facial image, facial recognition module 222 may detect a visual disconnection condition with respect to the client device that sent the video stream. In various examples, facial recognition module 222 may detect the disconnection condition if even a single subsequent frame does not include a matching facial image, if a threshold number of frames do not include a matching facial image, if a threshold number of contiguous frames do not include a matching facial image, and others. In this manner, facial recognition module 222 may implement one or more of the real-time communication session management techniques of this disclosure using facial recognition technology.

AV processing module 218 may also detect disconnection conditions based on audio streams received from client devices. In certain examples, disconnection conditions detected based on received audio streams (and/or audio portions of received AV streams) may be referred to herein as auditory disconnection conditions. AV processing module 218 may detect auditory disconnection conditions using one or both of speech recognition module 224 and voice recognition module 226. In some examples, speech recognition module 224 may determine that a received audio stream includes insufficient audio data. In certain examples, speech recognition module 224 may detect insufficient audio data based on one or both of silence and the presence of non-voice audio data in the received audio stream.

More specifically, speech recognition module 224 may detect silence based on a determination that host device 200 has not received audio data from a client device (e.g., as a dedicated audio stream, as an audio stream in conjunction with a sequence of frames of a video stream, and others). Additionally, speech recognition module 224 may detect non-voice audio data (e.g., in the form of sounds that are inconsistent with a human voice) in a received audio stream. In examples where speech recognition module 224 detects non-voice audio data in an audio stream, speech recognition module 224 may use various criteria to determine whether the non-voice audio data indicates an auditory disconnection condition. As one example, speech recognition module 224 may detect the auditory disconnection condition if a received audio stream includes a predetermined ratio/proportion of the duration of non-voice audio data as compared to voice audio data. As another example, speech recognition module 224 may detect the auditory disconnection condition based on a comparison of the volume (or amplitude) of the non-voice audio data to the volume of the voice audio data.

In these and other implementations, AV processing module 218 may use voice recognition module 226 to detect auditory disconnection conditions. For example, voice recognition module 226 may identify a representation of a voice in a received audio stream (e.g., at an initial early stage of the audio stream). Voice recognition module 226 may additionally determine whether the received audio stream includes audio data of at least a threshold length (e.g., duration) that matches the identified voice. If voice recognition module 226 determines that the audio stream does not include audio data of at least the threshold length matching the identified voice, voice recognition module 226 may detect an auditory disconnection condition (e.g., indicating that a main user of the sending client device has become inactive in the real-time communication session). In some such examples, voice recognition module 226 may apply various criteria to detect the auditory disconnection condition, such as requiring the audio data matching the identified voice to be contiguous (e.g., to show that the main user's participation is adequately substantial and/or continuous), among other criteria as well.

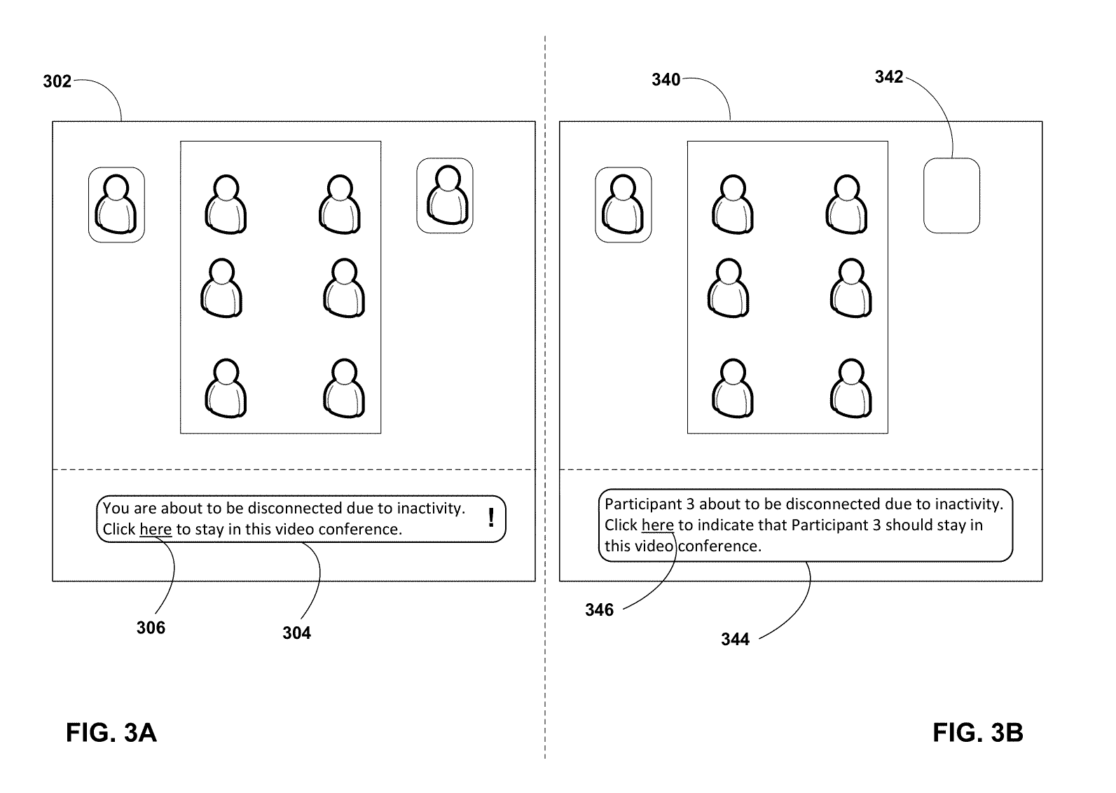

FIGS. 3A & 3B illustrate example user interfaces (UIs) 302 & 304 respectively, that a client device may display, in accordance with one or more techniques of this disclosure. While UI's 302 & 304 may be displayed by and/or reflect the activities of any device described herein, for purposes of illustration only, UI's 302 & 304 are described herein as being displayed by client device 102A to reflect the activities of host system 106 of FIG. 1.

UI 302 of FIG. 3A includes UI elements that represent participants at three locations (not called out for ease of illustration purposes only). In other implementations, UI 302 may include an element that represents the participant(s) using client device 102A (e.g., a “self-portrayal” element, which may provide a participant with a continuous representation of his/her appearance as seen by participants at other locations). Additionally, UI 302 includes prompt 304. In various examples, host system 106 may, responsive to detecting a disconnection condition associated with client device 102A, send an instruction to client device 102 to output prompt 304 (e.g., via display device of client device 102A).

As shown, prompt 304 may solicit a user input. More specifically, prompt 304 indicates to any participants using client device 102A that host system 106 has detected a disconnection condition (visual, auditory, etc.), and may disconnect client device 102A from the real-time communication session absent some action by the participant. In the example of FIG. 3A, prompt 304 solicits a user to respond by clicking at link 306 to avert disconnection of client device 102A from the real-time communication session. If a user responds to prompt 304 (e.g., by clicking at link 306 using a mouse, stylus, finger, or other input channel), client device 102A may forward the response to host system 106. Upson receiving the forwarded response to the prompt, host system 106 may determine whether or not to disconnect client device 102A based on the detected disconnection condition. For example, host system 106 may refrain from disconnecting client device 102A based on the received forwarded response to the prompt. In this manner, techniques of this disclosure may enable a participant to continue in a real-time communication session, in instances where a detected disconnection condition may be a false alarm (or “false positive”).

UI 340 of FIG. 3B illustrates a scenario in which host system 106 has detected a disconnection condition with respect to a different client device (e.g., client device 102C) in the real-time communication session. More specifically, the disconnection condition associated with client device 102C may be reflected by UI element 342. As shown, UI element 342 does not include a visual representation of a user, and may thereby indicate why host system 106 has detected a visual disconnection condition with respect to client device 102C. In the implementation illustrated in FIG. 3B, host system 106 may, responsive to detecting the visual disconnection condition of client device 102C, send an instruction to client device 102A (and, optionally, to client device 102B) to display prompt 344.

In turn, prompt 344 may solicit a user input from participant(s) using client device 102A to “vote” on whether host system 106 should disconnect client device 102C from the real-time communication session. A user may click at link 346 to indicate a vote in favor of client device 102C remaining in the real-time communication session, or may refrain from providing any input in order to allow host system 106 to disconnect client device 102C from the real-time communication session. Client device 102A may forward the response (or an indication of a lack of a response) to host system 106. In turn, host system 106 may determine, based on the received forwarded response(s) to the prompt, whether to disconnect client device 102C from the real-time communication session. In some implementations, host system may make the determination based on a number of votes received from all client devices other than from client device 102C.

Additionally, in some implementations, host system 106 may adjust certain characteristics based on prior disconnection heuristics accessible to host system 106. For example, the prior disconnection heuristics with respect to client device 102A may include various instances in which a user provided a response to prompt 304, thereby averting disconnection. In this example, host system 106 may adjust a visual disconnection condition associated with client device 102A to require a greater threshold time (thereby providing a greater allowance for participants to leave view before detecting a visual disconnection condition). Similarly, host system 106 may adjust disconnection conditions associated with client device 102C based on past voting results (e.g., providing greater allowance if client device 102C is more often voted to stay, less allowance if client device 102C is more often voted out of sessions). In this manner, host system 106 may use prior disconnection heuristics to generate adjusted characteristics for disconnection conditions associated with specific client devices.

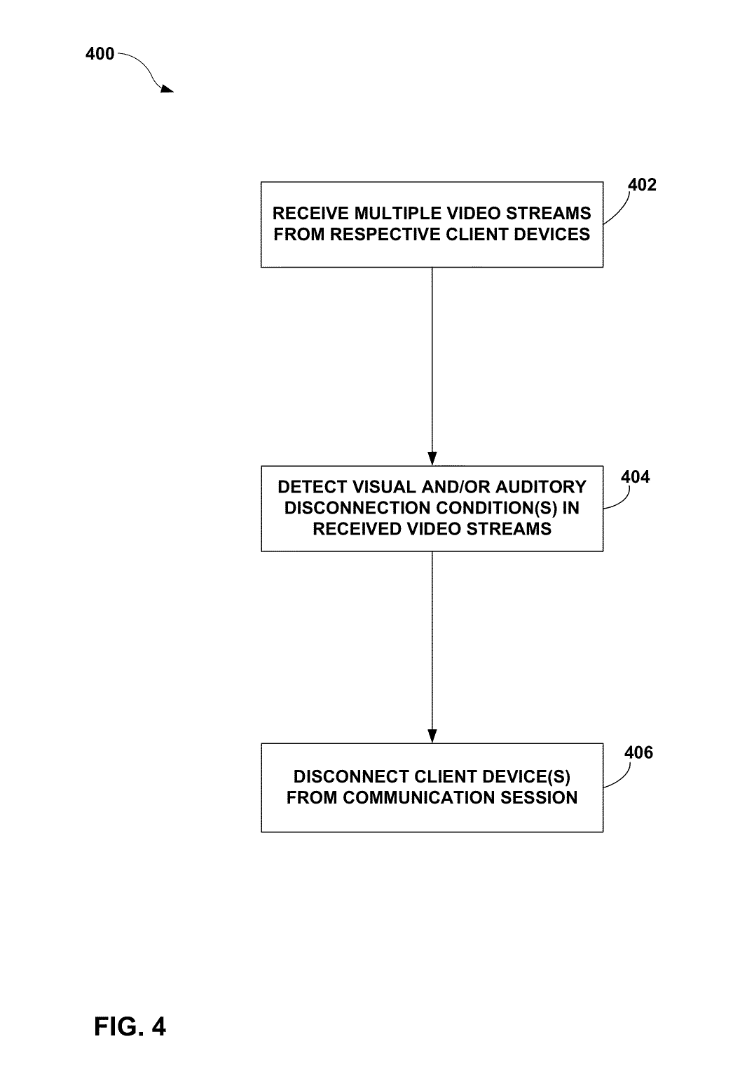

FIG. 4 is a flowchart illustrating an example process 400 which may be implemented by a computing device in accordance with one or more aspects of this disclosure. Process 400 may begin when a host system receives multiple video streams from respective client devices (402). For example, the host system may receive a first video stream from a first client device and a second video stream from a second client device, where the host system, the first client device, and the second client device are communicatively coupled to a real-time communication session. Additionally, the host system may detect visual and/or auditory disconnection condition(s) in the received video streams (404). For example, the host system may detect, in the second video stream, a disconnection condition that includes at least one of a visual disconnection condition and an auditory disconnection condition.

Additionally, the host system may disconnect one or more of the client devices from the communication session (406). As one example, the host system may, responsive to detecting the disconnection condition, disconnect the second client device from the real-time communication session. In one example, disconnecting the second client device from the real-time communication session may further include terminating, by the host system, the real-time communication session such that both of the first client device and the second client device are disconnected from the real-time communication session. In one example, where a third client device is communicatively coupled to the real-time communication session, the host system may, subsequent to disconnecting the second client device from the real-time communication session, continue the real-time communication session by enabling communication between the first client device and the third client device.

In some examples, detecting the disconnection condition may further include detecting, by the host system, a representation of a first face in the first video stream and a representation of a second face in the second video stream, and subsequent to detecting the representation of the first face and the representation of the second face, detecting, by the host system, an absence of the representation of the second face from the second video stream for at least a predetermined period of time. In one such example, the host system may detect an image of the first face in a frame of the first video stream and an image of the second face in a frame of the second video stream, store the image of the first face and the image of the second face as a reference facial image for the first video stream and a reference facial image for the second video stream, respectively, determine using facial recognition program(s) executable by the host system whether a subsequent sequence of frames of the second video stream includes a facial image that matches the reference facial image for the second video stream, where the subsequent sequence of frames is associated with the predetermined period of time, and responsive to determining that the subsequent sequence of frames of the second video stream does not include the facial image that matches the reference facial image for the second video stream, detect the visual disconnection condition.

In some examples, detecting the visual disconnection condition may further include detecting, by the host system, an inactivity associated with a sequence of frames of the second video stream, where the sequence of frames is associated with the predetermined period of time. In one such example, the host system may detect at least one of insufficient visual transition among the sequence of frames and insufficient audio data received by the host system in conjunction with receiving the sequence of frames, where the insufficient visual transition indicates a change between two or more frames of the sequence of frames that is less than a threshold change value, and where the insufficient audio data indicates one or more of 1) non-voice audio data received by the host system in conjunction with the sequence of frames, and 2) a determination that the host system has not received audio data in conjunction with receiving the sequence of frames.

In some examples, detecting the auditory disconnection condition may further include receiving, by the host system, a first audio stream associated with the received first video stream and a second audio stream associated with the received second video stream, and detecting, by the host system, an absence of authorized voice audio data from the received second audio steam. In one such example, the host system may detect, using one or more speech recognition programs executable by the host system, at least one conversation-concluding phrase in the received second audio stream.

In some such examples, the host system may identify, using one or more voice recognition programs executable by the host system, a representation of a first voice in the received first audio stream and a representation of a second voice in the received second audio stream, determine, using the voice recognition program(s), whether the received first audio stream includes audio data of at least a threshold length that matches the representation of the first voice and whether the received second audio stream includes audio data of at least the threshold length that matches the representation of the second voice, and responsive to determining that the received second audio stream does not include audio data of at least the threshold length that matches the representation of the second voice, detect the absence of the authorized voice audio data. In one such example, the host system may determine, using the voice recognition program(s), whether the received first audio stream includes contiguous audio data of at least the threshold length that matches the first voice and whether the received second audio stream includes contiguous audio data of at least the threshold length that matches the second voice, and responsive to determining that the received second audio stream does not include contiguous audio data of at least the threshold length, detect the absence of the authorized voice audio data.

In some examples, detecting the visual condition may further include detecting a standing gesture in at least one of the first video stream and the second video stream, where the standing gesture indicates a transition from a sitting posture to an upright posture. In this and other examples, the host system may, responsive to detecting the disconnection condition, send to the second client device, an instruction to output a prompt that solicits a user input, and receive, at a network interface of the host system from the second client device, a forwarded response to the prompt, where disconnecting the second client device from the real-time communication session is responsive to both of the detected disconnection condition and the received forwarded response to the prompt.

In some examples, detecting the disconnection condition may further include adjusting, by the host system based on one or more prior disconnection heuristics accessible to the host system, at least one characteristic of the detected disconnection condition, where disconnecting the second client device from the real-time communication session is responsive to both the detected disconnection condition and the at least one adjusted characteristic. In one example, the host system may, responsive to detecting the disconnection condition, send to the first client device, an instruction to output a prompt that solicits a user input, and receive, at a network interface of the host system from the first client device, a forwarded user input, where disconnecting the second client device from the real-time communication session is responsive to both the detected disconnection condition and the adjusted characteristic.

Techniques described herein may be implemented, at least in part, in hardware, software, firmware, or any combination thereof. For example, various aspects of the described embodiments may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

Techniques described herein may also be embodied or encoded in an article of manufacture including a computer-readable storage medium encoded with instructions. Instructions embedded or encoded in an article of manufacture including an encoded computer-readable storage medium, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer-readable storage media. Additional examples of computer readable medium include computer-readable storage devices, computer-readable memory, and tangible computer-readable medium. In some examples, an article of manufacture may comprise one or more computer-readable storage media.

In some examples, computer-readable storage media may comprise non-transitory media. The term “non-transitory” may indicate that the storage medium is tangible and is not embodied in a carrier wave or a propagated signal. In certain examples, a non-transitory storage medium may store data that can, over time, change (e.g., in RAM or cache).

In situations in which the systems discussed herein may collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Various examples have been described. These and other examples are within the scope of the following claims.

1. A method comprising:
receiving, by a host system comprising at least one processor, a first video stream from a first client device and a second video stream from a second client device, wherein the host system, the first client device, and the second client device are communicatively coupled to a real-time communication session;
detecting, by the host system and in the second video stream, a disconnection condition comprising a visual disconnection condition; and
responsive to detecting the disconnection condition, disconnecting, by the host system, the second client device from the real-time communication session.

2. The method of claim 1, wherein disconnecting the second client device from the real-time communication session further comprises:
terminating, by the host system, the real-time communication session such that both of the first client device and the second client device are disconnected from the real-time communication session.

3. The method of claim 1, wherein a third client device is communicatively coupled to the real-time communication session, the method further comprising:
subsequent to disconnecting the second client device from the real-time communication session, continuing, by the host system, the real-time communication session by enabling communication between the first client device and the third client device.

4. The method of claim 1, wherein detecting the visual disconnection condition further comprises:
detecting, by the host system, a representation of a first face in the first video stream and a representation of a second face in the second video stream; and
subsequent to detecting the representation of the first face and the representation of the second face, detecting, by the host system, an absence of the representation of the second face from the second video stream for at least a predetermined period of time.

5. The method of claim 4, further comprising:
detecting an image of the first face in a frame of the first video stream and an image of the second face in a frame of the second video stream;
storing, by the host system, the image of the first face and the image of the second face as a reference facial image for the first video stream and a reference facial image for the second video stream, respectively;
determining, by the host system and using one or more facial recognition programs executable by the host system, whether a subsequent sequence of frames of the second video stream includes a facial image that matches the reference facial image for the second video stream, wherein the subsequent sequence of frames is associated with the predetermined period of time; and
responsive to determining that the subsequent sequence of frames of the second video stream does not include the facial image that matches the reference facial image for the second video stream, detecting the disconnection condition.

6. The method of claim 4, wherein detecting the disconnection condition further comprises:
detecting, by the host system, an inactivity associated with a sequence of frames of the second video stream, wherein the sequence of frames is associated with the predetermined period of time.

7. The method of claim 6, wherein detecting the inactivity further comprises:
detecting, by the host system, at least one of insufficient visual transition among the sequence of frames and insufficient audio data received by the host system in conjunction with receiving the sequence of frames,
wherein the insufficient visual transition indicates a change between two or more frames of the sequence of frames that is less than a threshold change value, and
wherein the insufficient audio data indicates one or more of 1) non-voice audio data received by the host system in conjunction with the sequence of frames, and 2) a determination that the host system has not received audio data in conjunction with receiving the sequence of frames.

8. The method of claim 1, the method further comprising:
detecting, by the host system, an auditory disconnection condition at least in part by:
receiving, by the host system, a first audio stream associated with the received first video stream and a second audio stream associated with the received second video stream; and
detecting, by the host system, an absence of authorized voice audio data from the received second audio stream.

9. The method of claim 8, further comprising:
identifying, by the host system and using one or more voice recognition programs executable by the host system, a representation of a first voice in the received first audio stream and a representation of a second voice in the received second audio stream;
determining, using the voice recognition programs executable by the host system, whether the received first audio stream includes audio data of at least a threshold length that matches the representation of the first voice and whether the received second audio stream includes audio data of at least the threshold length that matches the representation of the second voice; and
responsive to determining that the received second audio stream does not include audio data of at least the threshold length that matches the representation of the second voice, detecting the absence of the authorized voice audio data.

10. The method of claim 9, further comprising:
determining, by the host system and using the one or more voice recognition programs executable by the host system, whether the received first audio stream includes contiguous audio data of at least the threshold length that matches the first voice and whether the received second audio stream includes contiguous audio data of at least the threshold length that matches the second voice; and
responsive to determining that the received second audio stream does not include contiguous audio data of at least the threshold length that matches the second voice, detecting the absence of the authorized voice audio data.

11. The method of claim 8, wherein detecting the auditory disconnection condition further comprises:
detecting, by the host system and using one or more speech recognition programs executable by the host system, at least one conversation-concluding phrase in the received second audio stream.

12. The method of claim 1, wherein detecting the visual disconnection condition further comprises:
detecting a standing gesture in at least one of the first video stream and the second video stream, wherein the standing gesture indicates a transition from a sitting posture to an upright posture.

13. The method of claim 1, further comprising:
responsive to detecting the disconnection condition, sending, by the host system and to the second client device, an instruction to output a prompt that solicits a user input; and
receiving, at a network interface of the host system and from the second client device, a forwarded response to the prompt, wherein disconnecting the second client device from the real-time communication session is responsive to both of the detected disconnection condition and the received forwarded response to the prompt.

14. The method of claim 1, wherein detecting the disconnection condition further comprises:
adjusting, by the host system and based on one or more prior disconnection heuristics accessible to the host system, at least one characteristic of the detected disconnection condition,
wherein disconnecting the second client device from the real-time communication session is responsive to both the detected disconnection condition and the at least one adjusted characteristic.

15. The method of claim 14, further comprising:
responsive to detecting the disconnection condition, sending, by the host system and to the first client device, an instruction to output a prompt that solicits a user input; and
receiving, at a network interface of the host system and from the first client device, a forwarded user input,
wherein disconnecting the second client device from the real-time communication session is responsive to both the detected disconnection condition and the adjusted characteristic.

16. A computer-readable storage device encoded with instructions that, when executed, cause one or more programmable processors of a host system to:
receive a first video stream from a first client device and a second video stream from a second client device, wherein the host system, the first client device, and the second client device are communicatively coupled to a real-time communication session;
detect, in the second video stream, a disconnection condition comprising a visual disconnection condition; and
responsive to detecting the disconnection condition, disconnect the second client device from the real-time communication session.

17. A host system comprising:
a network interface;
a memory; and
one or more programmable processors configured to:
receive, using the network interface, a first video stream from a first client device and a second video stream from a second client device, wherein the host system, the first client device, and the second client device are communicatively coupled to a real-time communication session;
detect, in the second video stream, a disconnection condition comprising a visual disconnection condition; and
responsive to detecting the disconnection condition, disconnect the second client device from the real-time communication session.

18. The host system of claim 17, wherein the one or more programmable processors are further configured to:
terminate the real-time communication session such that both of the first client device and the second client device are disconnected from the real-time communication session.

19. The host system of claim 17, wherein, to detect the disconnection condition, the one or more programmable processors are further configured to:
detect a representation of a first face in the first video stream and a representation of a second face in the second video stream; and
subsequent to detecting the representation of the first face and the representation of the second face, detect an absence of the representation of the second face from the second video stream for at least a predetermined period of time.

20. The host system of claim 19, wherein the one or more programmable processors are further configured to:
detect an image of the first face in a frame of the first video stream and an image of the second face in a frame of the second video stream;
store the image of the first face and the image of the second face as a reference facial image for the first video stream and a reference facial image for the second video stream, respectively;
determine, using one or more facial recognition programs executable by the host system, whether a subsequent sequence of frames of the second video stream includes a facial image that matches the reference facial image for the second video stream, wherein the subsequent sequence of frames is associated with the predetermined period of time; and
responsive to determining that the subsequent sequence of frames of the second video stream does not include the facial image that matches the reference facial image for the second video stream, detect the visual disconnection condition.
